(19) United States
(12) Patent Application Publication
(10) Pub. No.: US 2015/0056317 A1
(43) Pub. Date: Feb. 26, 2015

(54) THREE-DIMENSIONAL PRINTING APPARATUS

(71) Applicants: XYZprinting, Inc., New Taipei City (TW); KINPO ELECTRONICS, INC., NEW TAIPEI CITY (TW); Cal-Comp Electronics & Communications Company Limited, New Taipei City (TW)

(72) Inventor: Wu-Chieh Chen, New Taipei City (TW)

(73) Assignees: XYZprinting, Inc., New Taipei City (TW); Cal-Comp Electronics & Communications Company Limited, New Taipei City (TW); Kinpo Electronics, Inc., New Taipei City (TW)

(21) Appl. No.: 14/089,772

(22) Filed: Nov. 26, 2013

Related U.S. Application Data
(60) Provisional application No. 61/869,079, filed on Aug. 23, 2013.

(30) Foreign Application Priority Data
Oct. 18, 2013 (TW) 102137785

(51) Int. Cl. B29C 67/00

(52) U.S. Cl. CPC B29C 67/0051
USPC 425/130

(57) ABSTRACT

A three-dimensional printing apparatus is provided. The three-dimensional printing apparatus includes a base, a printing head, a plurality of material-supplying spools and a switching unit. The base has a carrying surface. The printing head is disposed above the base. The material-supplying spools respectively include a plurality of construction materials. The construction materials have a plurality of characteristics, and the characteristics are different from each other. The switching unit is configured to selectively connect at least one of the spools to the printing head according to the characteristics. The construction materials of the selected material-supplying spools are dispensed on the carrying surface by the printing head.

### CROSS-REFERENCE TO RELATED APPLICATION

This application claims the priority benefits of U.S. provisional application Ser. No. 61/869,079, filed on Aug. 23, 2013 and Taiwan application serial no. 102137785, filed on Oct. 18, 2013. The entirety of each of the above-mentioned patent applications is hereby incorporated by reference herein and made a part of this specification.

### BACKGROUND OF THE INVENTION

1. Field of the Invention

The invention relates to a printing apparatus. More particularly, the invention relates to a three-dimensional printing apparatus.

2. Description of Related Art

With the advance in computer-aided manufacturing (CAM), the manufacturing industry has developed rapid prototyping (RP), which can rapidly fabricate original concept designs. RP technology does not limit geometric shape, and the excellence of the technology is better demonstrated in more complex components. Moreover, manpower and processing time can be greatly reduced, and designed components on 3D computer-aided design (CAD) can be realistically rendered in a short amount of time. Not only can the components be touched, but the geometric curves thereof can also be truly appreciated. Moreover, the assembly ability of the components can be tested, and even the functions thereof can possibly be tested.

A number of RP methods are available, such as fused deposition modeling (FDM) and laminated object manufacturing (LOM). However, current three-dimensional printing apparatuses using RP to form three-dimensional objects generally only print in monochrome. In other words, current three-dimensional printing apparatuses generally can only fabricate monochromic three-dimensional objects. Even three-dimensional printing apparatuses capable of changing colors require manual intervention to replace the entire printing head assembly to change the construction materials therein. Therefore, current three-dimensional printing apparatuses are still very inconvenient to use, which not only wastes manpower, but also limits the variation and flexibility of fabricated three-dimensional objects.

### SUMMARY OF THE INVENTION

The invention provides a three-dimensional printing apparatus capable of readily switching between construction materials with different characteristics.

The three-dimensional printing apparatus of the invention includes a base, a printing head, a plurality of material-supplying spools and a switching unit. The base has a carrying surface, and the printing head is disposed above the base. The material-supplying spools respectively include a plurality of construction materials. In particular, the construction materials have a plurality of characteristics, and the characteristics are different from each other. The switching unit is configured to selectively connect at least one of the spools to the printing head according to the characteristics. The construction materials of the selected material-supplying spools are dispensed on the carrying surface by the printing head.

Based on the above, the three-dimensional printing apparatus of the invention includes a plurality of material-supplying spools. The material-supplying spools include a plurality of construction materials having characteristics different from each other. Moreover, a switching unit selectively connects at least one of the material-supplying spools to a printing head according to the characteristics of the construction materials, such that the construction materials of the selected material-supplying spools are dispensed on a base layer by layer through the printing head to form a three-dimensional object. In this way, the three-dimensional printing apparatus can automatically select and switch the colors or materials of the three-dimensional object to be fabricated without excessive manual operation. As a result, the usability and the printing flexibility of the three-dimensional printing apparatus are significantly enhanced.

To make the above features and advantages of the invention more comprehensible, several embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of an operating environment of a three-dimensional printing apparatus according to an embodiment of the invention.

FIG. 2 is a schematic block diagram of a portion of a three-dimensional printing apparatus according to an embodiment of the invention.

FIG. 3 is a schematic diagram of a three-dimensional printing apparatus according to an embodiment of the invention.

### DESCRIPTION OF THE EMBODIMENTS

Descriptions of the invention are given with reference to the exemplary embodiments illustrated with accompanied drawings. In addition, whenever possible, identical or similar reference numbers stand for identical or similar elements in the figures and the embodiments.

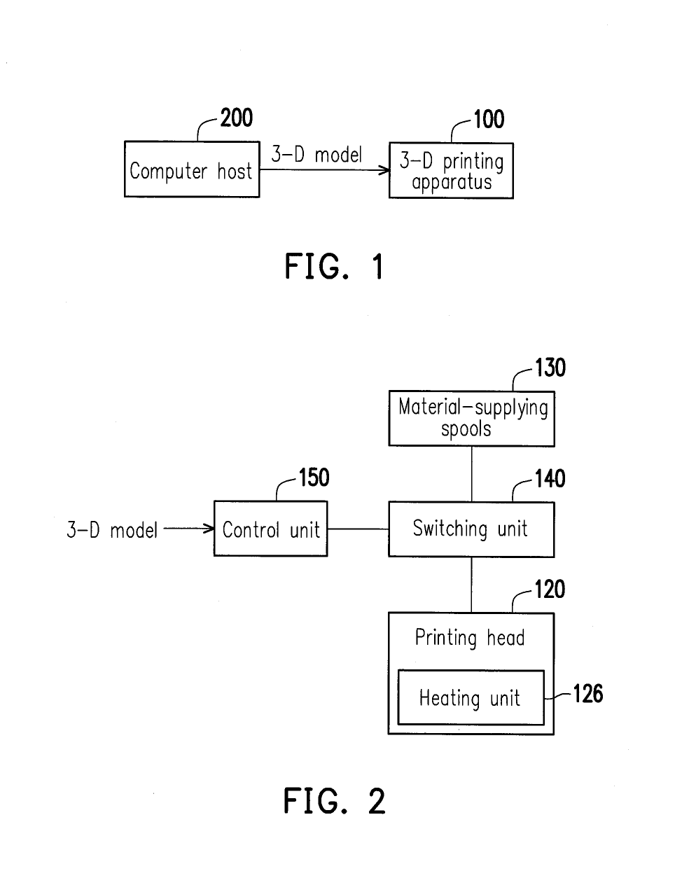

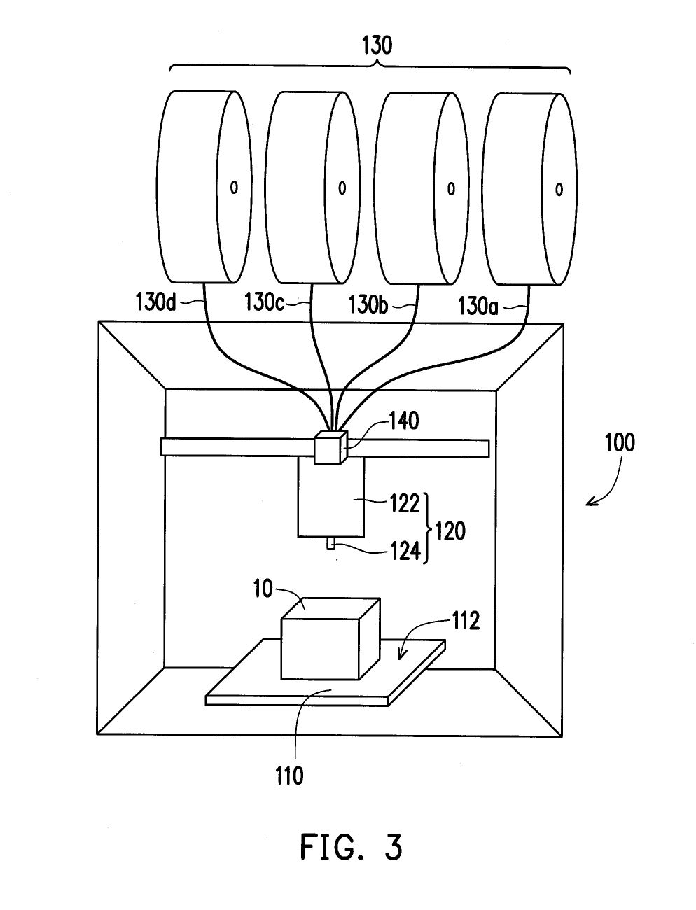

FIG. 1 is a schematic diagram of an operating environment of a three-dimensional printing apparatus according to an embodiment of the invention. FIG. 2 is a schematic block diagram of a portion of a three-dimensional printing apparatus according to an embodiment of the invention. FIG. 3 is a schematic diagram of a three-dimensional printing apparatus according to an embodiment of the invention. Referring to FIG. 1 to FIG. 3, in the present embodiment, a three-dimensional printing apparatus 100 is suitable for fabricating a three-dimensional object 10 from a three-dimensional model. The three-dimensional model is a three-dimensional digital image file, and the three-dimensional digital image file can be formed by, for instance, a computer-aided design (CAD) of a computer host 200 or an animation modeling software. The three-dimensional model is horizontally sliced to a plurality of cross-sections for the three-dimensional printing apparatus 100 to read the three-dimensional model. As a result, the three-dimensional printing apparatus 100 can fabricate the three-dimensional object 10 according to the cross-sections of the three-dimensional model. Moreover, in the present embodiment, the three-dimensional model may further include a plurality of different characteristic parameters, such as color parameters or texture parameters of the three-dimensional object to be fabricated. The three-dimensional printing apparatus 100 is configured to read the characteristic parameters and fabricate the three-dimensional object 10 accordingly.

In the present embodiment, the three-dimensional printing apparatus 100 includes a base 110, a printing head 120, a plurality of material-supplying spools 130 and a switching unit 140. The base 110 has a carrying surface 112 to carry construction materials dispensed by the printing head 120. The printing head 120 is disposed above the base 110 such that the construction materials are dispensed on the carrying surface 112 layer by layer. In the present embodiment, the base 110 may, for instance, move along a direction parallel to the carrying surface 112, and may also move or rotate along a normal direction of the carrying surface 112. The printing head 120 may, for instance, move along a direction parallel to the carrying surface 112. However, the present embodiment does not limit the direction of movement of each of the base 100 and the printing head 120. In the present embodiment, a plurality of material-supplying spools 130 respectively includes a plurality of construction materials. In particular, the construction materials have a plurality of characteristics, and the characteristics of the construction materials are different from each other. For instance, the colors or the textures of the construction materials of the plurality of material-supplying spools 130 are different from each other. In the present embodiment, the construction materials dispensed on the carrying surface 112 layer by layer through the printing head 120 may include a building material for building the main body of the three dimensional object, a support material for supporting the building materials, and a release material disposed between the building materials and the support material. More specifically, the construction materials dispensed on the carrying surface 112 may not only include a building material used to form the three-dimensional object 10, but may also include the support material for supporting the three-dimensional object 10 and the release material disposed between the building material and the support material. Moreover, after the construction materials dispensed on the carrying surface 112 are cured, the support material and the release material can be removed to obtain the three-dimensional object 10.

Specifically, the material-supplying spools 130 can be thermofusible solid spools composed of thermofusible construction materials, and the thermofusible solid spools may, for instance, be heated by a heating unit 126 disposed at the printing head 120 such that the construction materials are in a melting state. Next, the construction materials are extruded from the printing head 120 and stacked on the carrying surface 112 layer by layer to form a plurality of construction material layers. Then, a curing and drying process is, for instance, performed on the construction material layers to form the three-dimensional object 10. Of course, in other embodiments of the invention, the material-supplying spools 150 can also be pipelines for containing and feeding fluid or gel construction materials to the printing head 120 such that the fluid or gel construction materials are extruded through the printing head 120 and dispensed on the carrying surface 132. Then, a curing and drying process is, for instance, performed on the fluid or gel construction materials to form the three-dimensional object 10.

Based on the above, the switching unit 140 can be configured to selectively connect at least one of the material-supplying spools 130 to the printing head 120 according to the characteristics of the construction materials. The printing head 120 can dispense the construction materials of the selected material-supplying spools 130 on the carrying surface 112 layer by layer to form a plurality of construction material layers. In particular, the construction material layers are stacked upon one another to form the three-dimensional object 10. Specifically, the three-dimensional printing apparatus 100 may further include a control unit 150 coupled to the switching unit 140. The control unit 150 can, for instance, read the characteristic parameters of the three-dimensional model, and thereby select at least one of the construction materials according to the characteristics of the construction materials, and control the switching unit 140 to connect the material-supplying spools 130 corresponding to the construction materials of the selected material-supplying spools 130 to the printing head 120.

In an embodiment of the invention, the three-dimensional printing apparatus 100 may include material-supplying spools 130a, 130b, 130c, and 130d as shown in FIG. 3. In particular, the color characteristics of the construction materials of the material-supplying spools 130a, 130b, 130c, and 130d are different from each other. The control unit 150 can, for instance, read the color characteristic parameters of the three-dimensional model, and thereby select one of the construction materials according to the material characteristics, and control the switching unit 140 to connect the material-providing spool 130 corresponding to the selected construction materials to the printing head 120. For instance, the color of the construction material of the material-supplying spool 130a is red, the color of the construction material of the material-supplying spool 130b is yellow, the color of the construction material of the material-supplying spool 130c is blue, the color of the construction material of the material-supplying spool 130d is white, and the color characteristic parameter of the three-dimensional model is red. Therefore, the control unit 150 selects the red construction material after reading the color characteristic parameter of the three-dimensional model, and controls the switching unit 140 to connect the corresponding material-supplying spool 130a to the printing head 120 such that the red construction material is dispensed on the carrying surface 112 through the printing head 120 to form a red three-dimensional object 10. The three-dimensional printing apparatus 100 may further switch between the material-supplying spools 130a, 130b, 130c, and 130d through the switching unit 140 during the fabrication of the three-dimensional object 10 so as to switch between different colors of the construction materials during the fabrication of the three-dimensional object 10, such that the fabricated three-dimensional object 10 has different colors.

In another embodiment of the invention, the texture characteristics of the construction materials of the material-supplying spools 130a, 130b, 130c, and 130d are different from each other, and the textures may include, for instance, powder, liquid, or gel. Of course, the present embodiment does not limit the texture of the construction material. The control unit 150 can read the texture characteristic parameters of the three-dimensional model, and thereby selects one of the construction materials according to the texture characteristics of the construction materials, and control the switching unit 140 to connect the material-supplying spools 130 corresponding to the selected construction materials to the printing head 120. For instance, the texture of the construction material of the material-supplying spool 130a is powder, the texture of the construction material of the material-supplying spool 130b is liquid, and the texture of the construction materials of the material-supplying spool 130c is gel. The control unit 150 selects the gel construction materials after reading the material characteristic parameters of the three-dimensional model, and controls the switching unit 140 to connect the corresponding material-supplying spool 130c to the printing head 120 such that the gel construction materials are dispensed on the carrying surface 112 by the printing head 120. However, those having ordinary skill in the art should understand that, the invention does not limit the number of the material-supplying spools 130 and the type and characteristics of the construction materials contained in the material-supplying spools 130.

In another embodiment of the invention, the printing head 120 can further include a mixing chamber 122 and a discharge outlet 124 as shown in FIG. 3. In particular, the discharge outlet 124 is connected to the mixing chamber 122. In the present embodiment, the color characteristics of the construction materials of the material-supplying spools 130a, 130b, 130c, and 130d are different from each other. Moreover, the switching unit 140 can selectively connect at least two of the material-supplying spools 130 to the printing head 120 according to the color characteristics. More specifically, the control unit 150 can read the color characteristic parameters of the three-dimensional model, and thereby select at least two of the construction materials according to the characteristics of the construction materials, and control the switching unit 140 to connect the material-supplying spools 130 corresponding to the selected construction materials to the printing head 120. Next, the heating unit 126 can be configured to heat the construction materials of the selected material-supplying spools 130 to a melting state such that the construction materials can be mixed in the mixing chamber 122. The construction materials are dispensed on the carrying surface 112 through the discharge outlet 124 after mixing.

For instance, in the present embodiment, the color of the construction material of the material-supplying spool 130a is red, the color of the construction material of the material-supplying spool 130b is yellow, the color of the construction material of the material-supplying spool 130c is blue, the color of the construction material of the material-supplying spool 130d is white, and the color characteristic parameter of the three-dimensional model is, for instance, green. The control unit 150 can select the yellow and blue construction materials by reading the color characteristic parameters and control the switching unit 140 to connect the corresponding material-supplying spool 130b and the material-supplying spool 130c to the printing head 120. Then, the construction materials of the selected material-supplying spool 130b and the material-supplying spool 130c are heated to a melting state through the heating unit 126 such that the construction materials of the selected material-supplying spool 130b and the material-supplying spool 130c can be mixed in the mixing chamber 122. Next, green construction material is dispensed on the carrying surface 112 through the discharge outlet 124 after mixing to form a green three-dimensional object 10. In the present embodiment, the mixing ratio of the construction materials can be, for instance, controlled by the control unit 150. In this way, the color of the three-dimensional object 10 fabricated by the three-dimensional printing apparatus 100 can be more realistic and diverse. Moreover, the three-dimensional printing apparatus 100 can further switch between the material-supplying spools 130a, 130b, 130c, and 130d through the switching unit 140 during the fabrication of the three-dimensional object 10 so as to switch between different colors pf the construction materials during the fabrication of the three-dimensional object 10, such that the fabricated three-dimensional object 10 has a plurality of different colors.

Based on the above, the three-dimensional printing apparatus of the invention includes a plurality of material-supplying spools. The material-supplying spools include a plurality of construction materials having characteristics different from each other. Moreover, a control unit is used to select at least one of the construction materials according to the characteristics of the construction materials, and control a switching unit to connect the corresponding material-supplying spools to a printing head such that the selected construction materials are dispensed on a base layer by layer through the printing head to form a three-dimensional object. In this way, the three-dimensional printing apparatus can automatically select and switch the colors or textures of the three-dimensional object to be fabricated without excessive manual operation. As a result, the usability and the printing flexibility of the three-dimensional printing apparatus are significantly enhanced.

Although the invention has been described with reference to the above embodiments, it will be apparent to one of the ordinary skill in the art that modifications to the described embodiments may be made without departing from the spirit of the invention. Accordingly, the scope of the invention is defined by the attached claims not by the above detailed descriptions.

What is claimed is:

1. A three-dimensional printing apparatus, comprising:
a base having a carrying surface;
a printing head disposed above the base;
a plurality of material-supplying spools comprising a plurality of construction materials respectively, wherein the construction materials have a plurality of characteristics, and the characteristics are different from each other; and
a switching unit configured to selectively connect at least one of the material-supplying spools to the printing head according to the characteristics, wherein the construction materials of the selected material-supplying spools are dispensed on the carrying surface by the printing head.

2. The three-dimensional printing apparatus as claimed in claim 1, further comprising a control unit coupled to the switching unit, wherein the control unit selects at least one of the construction materials according to the characteristics and controls the switching unit to connect the selected material-supplying spools to the printing head.

3. The three-dimensional printing apparatus as claimed in claim 1, wherein the characteristics comprise color or texture.

4. The three-dimensional printing apparatus as claimed in claim 3, wherein the texture of each of the construction materials comprises powder, liquid, or gel.

5. The three-dimensional printing apparatus as claimed in claim 1, wherein the printing head dispenses the construction materials of the selected material-supplying spools on the carrying surface layer by layer to form a plurality of construction material layers, and the construction material layers are stacked upon one another to form a three-dimensional object.

6. The three-dimensional printing apparatus as claimed in claim 1, wherein the switching unit selectively connects one of the material-supplying spools to the printing head according to the characteristics.

7. The three-dimensional printing apparatus as claimed in claim 1, wherein the switching unit selectively connects at least two of the material-supplying spools to the printing head according to the characteristics.

8. The three-dimensional printing apparatus as claimed in claim 7, wherein the characteristics comprise color.

9. The three-dimensional printing apparatus as claimed in claim 7, wherein the printing head further comprises a mixing chamber and a discharge outlet, the discharge outlet is connected to the mixing chamber, and the construction materials of the selected material-supplying spools are mixed in the mixing chamber and are dispensed on the carrying surface through the discharge outlet.

10. The three-dimensional printing apparatus as claimed in claim 9, further comprising a heating unit configured to heat the construction materials of the selected material-supplying spools to a melting state such that the construction materials are mixed in the mixing chamber.
